(19) United States
(12) Patent Application Publication
(10) Pub. No.: US 2009/0323794 A1
(43) Pub. Date: Dec. 31, 2009

(54) Transmitter Equalization Method and System

(76) Inventors: Kathy Tian, Sunnyvale, CA (US); Harry Muljono, San Ramon, CA (US)

Correspondence Address: KED & ASSOCIATES, LLP;INTEL CORPORATION, P.O. BOX 221200, CHANTILLY, VA, 20153-1200, US

(21) Appl. No.: 12/164,950

(22) Filed: Jun. 30, 2008

(51) Int. Cl. H04L 27/01; H04L 27/06

(52) U.S. Cl. 375/232; 375/344

(57) ABSTRACT

A method is provided to determine transmitter equalization coefficients and a number of transmitter equalization taps. The method may include transmitting a first signal pattern at a first frequency across a channel to a receiver and determining a first eye height of the received clock signal pattern at the receiver. The method may also include transmitting a second signal pattern at a second frequency across the channel to the receiver and determining a second eye height of the received clock signal pattern at the receiver. Transmitter equalization coefficients may then be determined based on the determined first eye height and the determined second eye height.

### BACKGROUND

1. Field

Embodiments of the present invention may relate to transmitter equalization.

2. Background

Advances in silicon process technology have led to an increase in backplane speeds. However, high backplane speeds may result in signal degradation over longer motherboard channels or traces. Signal degradation may be caused by dielectric losses. Discontinuities with improperly matched impedances between a transmitter, a channel and a receiver may also contribute to signal degradation.

### BRIEF DESCRIPTION OF THE DRAWINGS

Arrangements and embodiments may be described in detail with reference to the following drawings in which like reference numerals refer to like elements and wherein:

FIG. 1 is a diagram of a transmitter/receiver system according to an example embodiment of the present invention;

FIG. 2 is a flow chart illustrating a method to determine transmitter equalization coefficients according to an example embodiment of the present invention;

FIG. 3 is a graph showing an equalized channel response according to an example embodiment of the present invention; and

FIG. 4 is a flow chart illustrating a method to determine a number of transmitter equalization taps according to an example embodiment of the present invention.

### DETAILED DESCRIPTION

Equalization is a technique to determine transmitter equalization coefficients that may be used to equalize frequency components of signals that are received over a transmission channel to compensate for losses, such as high frequency losses.

Equalization coefficients may be determined by running simulations with a model transmitter, transmission channel and receiver to determine an optimal eye height (EH) and eye width (EW). The computed equalization coefficients may then be programmed into the transmitter before actual transmission. However, this may result in either under-equalization or over-equalization of the channel and thus may increase bit-error-rate (BER) and consume more power.

Equalization coefficients may also be determined by applying all possible combinations of transmitter equalization coefficients until an optimal setting is determined. However, this may be exhaustive and may become proportionately time consuming as the number of taps and coefficient bits increases.

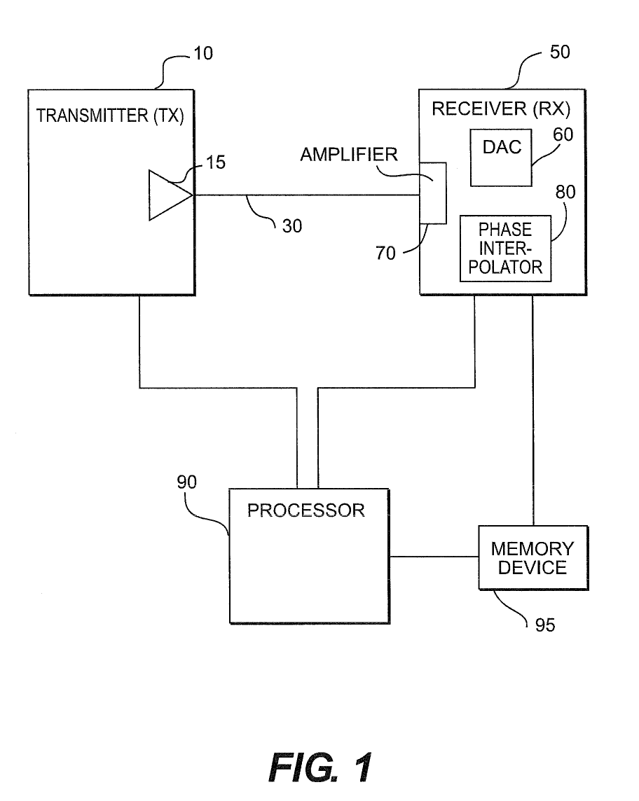

FIG. 1 is a diagram of a transmitter/receiver system according to an example embodiment of the present invention. Other embodiments and configurations are also within the scope of the present invention. More specifically, FIG. 1 shows a transmitter (TX) 10 and a receiver (RX) 50. The transmitter 10 and the receiver 50 may be connected together by a channel 30, such as a trace of a motherboard or an interconnect.

The transmitter 10 and the receiver 50 may be any one of a number of different components that may be coupled together by the channel 30. For example, the transmitter 10 and/or the receiver 50 may be chipsets, processors and/or other components that are connected by the channel 30 on a motherboard. The transmitter 10 and/or the receiver 50 may also be memory, graphic, or input/output (I/O) chips.

For ease of illustration, FIG. 1 only shows a single channel although other numbers of channels may also be provided between other transmitters in parallel with the transmitter 10 and/or other receivers in parallel with the receiver 50. The channel 30 may also be considered an interconnect or a trace, for example.

The transmitter 10 may include a driver 15 to drive or transmit clock signals onto and across the channel 30 at different ones of a plurality of frequencies. A processor 90 and a memory device 95 may also be provided within the system. The processor 90 may perform various operations at least with respect to the transmitter 10, the receiver 50 and the channel 30. For example, the processor 90 may determine and communicate transmitter equalization coefficients to the transmitter 10. The processor 90 may also determine and communicate the number of equalization taps to the transmitter 10 for the transmission of signals across the channel 30. The processor 90 may be provided external to the transmitter 10 and the receiver 50. The processor 90 may be either a circuit or firmware, for example.

The receiver 50 may include an operational amplifier (AMP) 70 (or comparator), a digital-to-analog converter (DAC) 60 and a phase interpolator (PI) 80. The amplifier 70 (or comparator) may receive clock signals from the transmitter 10 across the channel 30. The DAC 60 may be coupled to the amplifier 70 to adjust the amplifier 70. The Pi 80 may be coupled to the amplifier 70 to adjust the amplifier 70.

A determination of the various eye heights at a plurality of frequencies may be achieved by adjusting the amplifier 70 using the DAC 60. Accordingly, the amplifier 70 and the DAC 60 may be used to determine each of the eye heights.

The processor 90 (or other digital logic) may receive the measured (or determined) EH and the measured (or determined) EW and determine equalization (EQ) coefficients and/or a number of equalization taps. Data output from the receiver 50 may also be provided to the memory device 95 prior to being provided to the processor 90.

The transmitter 10 may transmit a clock signal at full frequency (010101) across the channel 30 to the receiver 50. The receiver 50 may determine the EH and the EW of the full frequency clock signal received at the receiver 50. The processor 90 may receive information regarding the determined EH and the determined EW of the received clock signals (010101) at full frequency. This full frequency may also hereafter be referred to as a first frequency. Data of the measured eye height and the eye width may be stored in the memory device 95 (along with information to indicate the first frequency).

The transmitter 10 may additionally transmit the clock signal at a reduced frequency, such as a ½ frequency (or a second frequency) (00110011), across the channel 30 to the receiver 50. The receiver 50 may receive the clock signals and determine (or measure) an eye height (EH) and determine (or measure) an eye width of the clock signals received at the second frequency. The processor 90 may receive the determined EH and EW. Data of the determined EH and the determined EW may be stored in the memory device 95 (along with information to indicate the second frequency). Data output from the receiver 50 may also be provided to the memory device 95 prior to being provided to the processor 90.

The transmitter 10 may also transmit the clock signal at a still reduced frequency (or third frequency), such as a ⅓ frequency (000111000111), across the channel 30 to the receiver 50. The receiver 50 may receive the clock signals and determine the EH and determine the EW of the received signals at the third frequency. The processor 90 may receive the determined EH and EW. Data of the determined EH and the determined EW may be stored in the memory device 95 (along with information to indicate the third frequency). Data output from the receiver 50 may also be provided to the memory device 95 prior to being provided to the processor 90.

The processor 90 may analyze the determined eye heights at the various frequencies, such as the first, second and third frequencies, to determine a frequency response of the channel 30 based on the determined eye heights. The processor 90 may determine an inverse of the frequency response (i.e., an inverse frequency response) of the channel 30 based on determined frequency response. The inverse frequency response of the channel 30 may indicate the transmitter equalization coefficients of the channel 30. Thus, the processor 90 may determine transmitter equalization coefficients based on determined eye heights. The transmitter equalization coefficients may be communicated to the transmitter 10 so that the transmitter 10 applies the equalization coefficients for subsequent transmission of digital signals across the channel 30 to the receiver 50. That is, signals to be transmitted are adjusted by the coefficients through the driver 15. For example, the transmitter 10 may adjust parameters of the driver 15 based on the determined transmitter equalization coefficients (which are based on the determined inverse frequency response). Subsequently transmitted signals from the transmitter 10 and across the channel to the receiver 50 may use the equalization coefficients and/or parameters that have been determined.

The processor 90 may also determine a number of equalization taps for the transmitter 10 based on the information relating to the determined eye widths (and their respective frequencies). For example, the processor 90 may determine a number of equalization taps by analyzing the eye heights at the various frequencies, such as the first, second and third frequencies. The number of equalization taps may also be based on ratios of the eye heights and a comparison of the ratios with threshold(s). The determined number of equalization taps may be communicated to the transmitter 10 so that the transmitter 10 may apply the determined number of equalization taps for subsequent transmission of digital signals across the channel 30 to the receiver 50.

As one example, a ratio may be determined of the determined EH at a first frequency to the determined EH at a second frequency. The ratio may be compared to a threshold and a number of equalization taps may be determined based on the comparing. These operations may be repeated with additionally determined EHs.

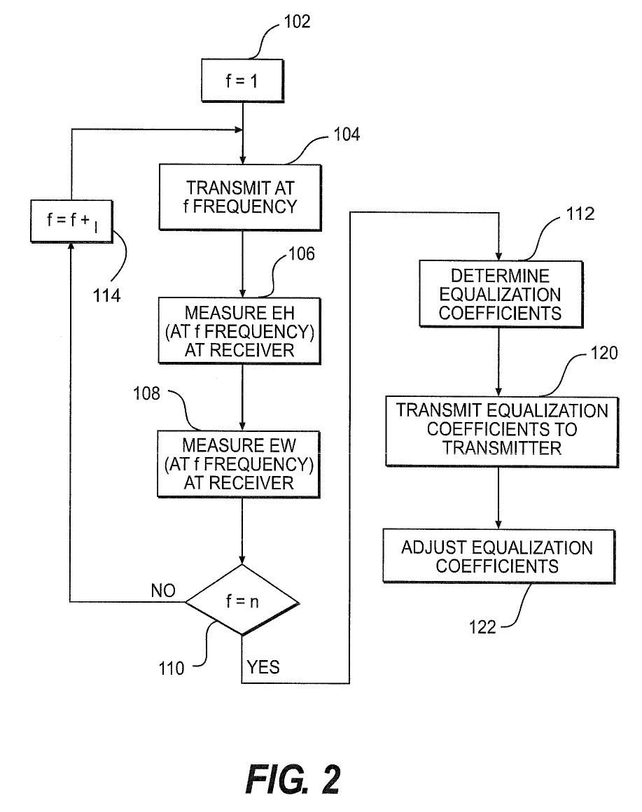

FIG. 2 is a flow chart illustrating a method to determine transmitter equalization coefficients according to an example embodiment of the present invention. Other operations, orders of operations and embodiments are also within the scope of the present invention. FIG. 2 references a transmitter that may correspond to the transmitter 10 of FIG. 1 and references a receiver that may correspond to the receiver 50 of FIG. 1.

FIG. 2 shows that, in operation 102, an initial frequency number (f) is set to a 1 to represent a first or a full frequency. The full frequency may represent a highest frequency possible across the channel. In operation 104, the transmitter may transmit clock signals at the f frequency. For example, the f frequency may be a first (or full) frequency. In operation 106, the eye height (EH) of the clock signal at the f frequency may be measured at the receiver. In operation 108, the eye width (EW) of the clock signals at the f frequency may be measured at the receiver. FIG. 2 shows operation 106 prior to operation 108. However, the method is not limited to the operation 106 being performed prior to the operation 108.

In operation 110, a determination may be made whether f equals n, where n represents a predetermined number of frequencies. If the determination is negative (meaning f does not equal n), then a value of f may be increased by 1 to 2, for example, in operation 114. For example, f may become 2. In operation 104, the transmitter may transmit clock signals at another frequency, such as at a second or ½ frequency. Operations 104, 106 and 108 at the second or ½ frequency may then be performed in order to determine data relative to the clock signals transmitted at the second or ½ frequency.

In operation 110, another determination may be made whether the current f equals n. As one example, if the determination is negative (meaning that f does not equal n), then f may be increased by 1 to 3, for example, in operation 114. In operation 104, the transmitter may transmit clock signals at another frequency, such as at a third or ⅓ frequency. Operations 104, 106, and 108 at the third or ⅓ frequency may then be performed in order to determine data relative to the clock signals transmitted at the third or ⅓ frequency.

If the determination in operation 110 is positive (meaning that f equal n), then operations may proceed to operation 112.

In operation 112, the processor may determine transmitter equalization coefficients based on data regarding the signals at the various frequencies, such as data at the first, second and third frequencies. The determined transmitter equalization coefficients may be transmitted to the transmitter in operation 120. In operation 122, the equalization coefficients of the transmitter may be adjusted to the determined transmitter equalization coefficients. The transmitter may transmit further signals using the adjusted transmitter equalization coefficients.

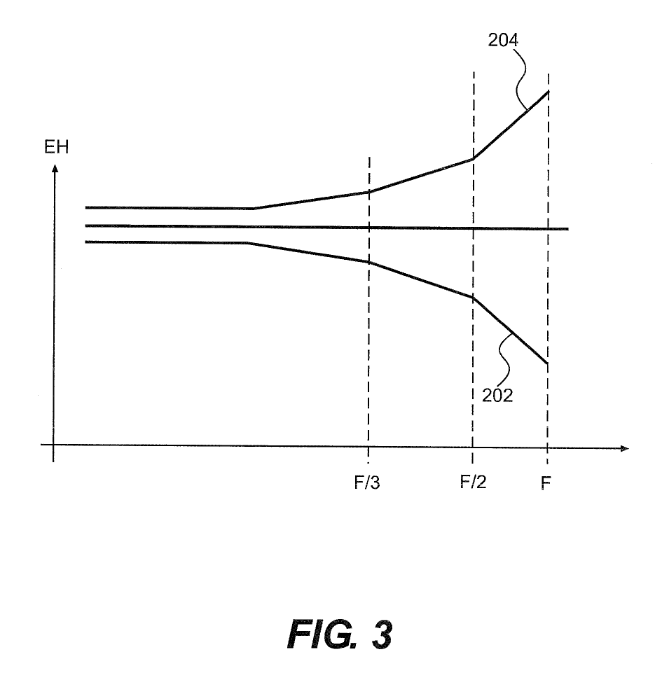

FIG. 3 is a graph showing an equalized channel response according to an example embodiment of the present invention. Other embodiments, graphs and data are also within the scope of the present invention. More specifically, FIG. 3 shows a graph with a frequency of a transmitted clock signal along a horizontal axis and an eye height (EH) along a vertical axis. The graph shows a frequency response of a channel along a line 202 based on the measured eye heights and a plurality of different frequencies. The graph also shows an inverse frequency response of the channel along a line 204. The inverse frequency response represents an inverse of the frequency response along the line 202. The inverse frequency response along the line 204 represents data to improve (or optimize) the transmitter equalization coefficients. The coefficients may be determined using the inverse (1/EH) of the EH at corresponding frequencies.

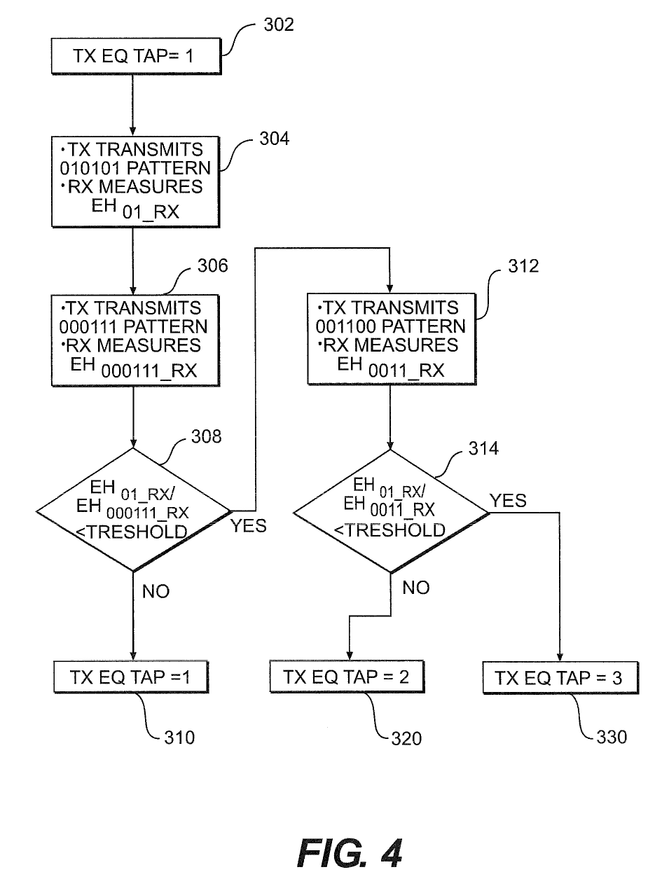

FIG. 4 is a flow chart illustrating a method to determine a number of equalization taps according to an example embodiment of the present invention. Other operations, orders of operations and embodiments are also within the scope of the present invention. FIG. 4 only shows 1-3 numbers of equalization taps to be determined. However, other numbers of equalization taps may also be determined using clock signals or patterns transmitted by the transmitter. FIG. 4 references a transmitter that may correspond to the transmitter 10 of FIG. 1 and references a receiver that may correspond to the receiver 50 of FIG. 1.

FIG. 4 shows that the transmitter (TX) may start with 1 equalization (EQ) tap in operation 302. In operation 304, the transmitter may transmit first clock signals at full frequency, such as a 010101 pattern, to the receiver. The receiver (RX) may measure eye height EH₀₁_{_{—}}_{RX} based on the received first clock signals. In operation 306, the transmitter may transmit second clock signals at ⅓ of the frequency, such as a 000111 pattern, to the receiver. The receiver may measure the eye height EH₀₀₀₁₁₁_{_{—}}_{RX} based on the received second clock signals. In operation 308, a determination may be made whether a ratio of EH₀₁_{_{—}}_{RX} to EH₀₀₀₁₁₁_{_{—}}_{RX} is less than a threshold. The threshold may be determined empirically.

If the determination is negative in operation 308 (meaning the ratio is greater than the threshold), then operation 310 determines that the number of transmitter equalization taps for the transmitter is 1. Information may be communicated to the transmitter such that future transmissions by the transmitter will include this number of equalization taps.

If the determination is positive in operation 308 (meaning the ratio is less than the threshold), then the transmitter may transmit third clock signals at ½ frequency, such as a 0011 pattern, to the receiver in operation 312. The receiver may measure eye height EH₀₀₁₁_{_{—}}_{RX} based on the received third clock signals. In operation 314, a determination may be made whether a ratio of EH₀₁_{_{—}}_{RX} to EH₀₀₁₁_{_{—}}_{RX} is less than a threshold. The threshold may be determined empirically. The threshold in operation 308 may be different than the threshold in operation 308.

If the determination is negative in operation 314 (meaning the ratio is greater than the threshold), then operation 320 determines that the number of transmitter equalization taps for the transmitter is 2. On the other hand, if the determination is positive in operation 314 (meaning the ratio is less than the threshold), then operation 330 determines that the number of transmitter equalization taps for the transmitter is 3. Information regarding the number of taps may be communicated to the transmitter such that future transmissions by the transmitter will include this number of equalization taps.

Embodiments of the present invention may provide a method to calculate transmitter equalization coefficients for a transmission channel. The method can be applied to various kinds of multiprocessors and/or communication systems that use transmission channels.

A frequency response for a transmission channel may be generated. This may include transmitting a pattern of clock signals across the transmission channel. The clock signals may be at various frequencies, such as full frequency, ½ frequency, ⅓ frequency, etc. Eye heights may then be determined (or measured) at the receiver by adjusting a DAC of the receiver. The eye heights may also be compared or analyzed at multiple frequencies to arrive upon the frequency response of the channel.

An inverse of the frequency response may be determined or calculated to determine the transmitter equalization coefficients. For example, in a 3-tap transmission equalization system, the eye height may determined using the following formula:

Eₜ₌X*Dₜ₋₁+Y*Dₜ+Z*Dₜ₊₁−(X+Z). Equation (1)

, where X is a pre-cursor coefficient, Y is a cursor coefficient and Z is a post cursor coefficient, X>Z and Dₙ is data at time ‘n’ with a value of 0 or 1. The digital value of Eₜ may be driven to the driver of the transmitter. The driver may act as a digital-to-analog converter and convert the digital value of Eₜ onto the channel (or transmission line). The coefficients X, Y and Z have been transmitted from the processor. Once the X, Y and Z values are received, X, Y and Z registers are updated and subsequent Eₜ values are calculated using the updated coefficients.

The following table illustrates various values for coefficients X, Y and Z for different frequency signals.

| Precursor | Cursor | Postcursor |
|---|---|---|
| X | Y | Z |

X * Dₜ₋₁ + Y * Dₜ₀ + Z * Dₜ₊₁ − (X + Z), where Dₙ is data at time n with digital value of 0 or 1 (equation 1)

| | Full Frequency Pattern | | | | time -> | | | | | |
|---|---|---|---|---|---|---|---|---|---|---|
| | 0 | 1 | 0 | 1 | 0 | 1 | 0 | 1 | 0 | 1 |
| TX Swing | undefined | Y − X − Z | 0 | Y − X − Z | 0 | Y − X − Z | 0 | Y − X − Z | 0 | Y − X − Z |
| | Half Frequency Pattern | | | | | | | | | |
| | 0 | 0 | 1 | 1 | 0 | 0 | 1 | 1 | 0 | 0 |
| TX Swing | undefined | −Z | Y − Z | Y − X | −X | −Z | Y − Z | Y − X | −X | −Z |
| | Third Frequency Pattern | | | | | | | | | |
| | 0 | 0 | 0 | 1 | 1 | 1 | 0 | 0 | 0 | 1 |
| TX Swing | undefined | −X − Z | −Z | Y − Z | Y | Y − X | −X | −X − Z | −Z | Y − Z |

Thus, for a full frequency pattern of 010101:

EH₀₁_{_{—}}_{TX}=Y−X−Z, by applying the inverse channel response, Y−X−Z=1

For a half frequency pattern of 0011,

EH₀₀₁₁_{_{—}}_{TX}=Min (Y−Z, Y−X) and Max (−X, −Z)=Y−X+Z=EH₀₁_{_{—}}_{RX}/EH₀₀₁₁_{_{—}}_{RX}

Additionally, for a third frequency pattern of 000111,

EH₀₀₀₁₁₁_{_{—}}_{TX}=Min (Y−Z,Y, Y−X) and Max (−X,−X−Z,−Z)=Y+X+Z=EH₀₁_{_{—}}_{RX}/EH₀₀₀₁₁₁_{_{—}}_{RX}

Embodiments of the present invention may calculate the transmitter equalization coefficients and apply the calculated coefficients to the transmission channel adaptively. Additionally, as discussed above, the number of equalization taps may also be calculated.

Embodiments of the present invention may provide that at least two clock signals may be separately transmitted across a transmission channel, each at a respective frequency. A corresponding eye height for each frequency may be measured at the respective frequency. For example, a clock signal having a 010101 pattern may be transmitted across the channel and an eye height EH₀₁_{_{—}}_{RX} may be measured at the receiver. A clock signal having a 000111 pattern may be transmitted across the channel and an eye height EH₀₀₀₁₁₁_{_{—}}_{RX} may be measured at the receiver.

A ratio of the eye heights may be computed. For example, a ratio of EH₀₁_{_{—}}_{RX} to EH₀₀₀₁₁₁_{_{—}}_{RX} may be calculated. The ratio may then be compared with a threshold value. If the ratio is greater than the threshold value, then the number of equalization taps may be 1. However, if the ratio is less than the threshold, then a clock signal having a 001100 pattern may be transmitted across the channel and an eye height EH₀₀₁₁_{_{—}}_{RX} may be measured at the receiver. A ratio of EH₀₁_{_{—}}_{RX} to EH₀₀₁₁_{_{—}}_{RX} may be calculated. The ratio may then be compared with a threshold value. If the ratio is greater than the threshold value, then the number of equalization taps may be 2. On the other hand, if the ratio is less than the threshold value, then the number of equalization taps may be 3. Additional clock signals, comparisons and ratios may also be used to determine greater than 3 equalization taps.

The above described technique may be used in any system that uses a transmission channel to communicate with a receiver. Examples of such systems include, but are not limited to, multiprocessors, communication devices, etc.

The above-described techniques may optimize or improve channel performance and a number of equalization taps. Optimization of taps may result in a substantial decrease in bit-error-rate and power consumption.

The above-described techniques may also be used to calculate the transmission channel speed before the adaptive transmitter equalization is performed. For example, when the eye-heights display a margin that is fewer than expected, the receiver may communicate to the transmitter to reduce the speed of the transmission channel.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method comprising:
transmitting a first signal at a first frequency across a channel to a receiver;
determining a first eye height of the first signal at the first frequency received at the receiver;
transmitting a second signal at a second frequency across the channel to the receiver;
determining a second eye height of the second signal at the second frequency received at the receiver; and
determining transmitter equalization coefficients based on the determined first eye height and the determined second eye height.

2. The method of claim 1, wherein determining the transmitter equalization coefficients includes:
determining a frequency response of the channel based on the determined first eye height and the determined second eye height; and
determining an inverse frequency response of the channel based on the determined frequency response.

3. The method of claim 1, further comprising adjusting signals to be transmitted from the transmitter using the transmitter equalization coefficients.

4. The method of claim 3, further comprising transmitting the adjusted signals from the transmitter and across the channel to the receiver.

5. The method of claim 1, wherein determining the first eye height includes adjusting an amplifier at the receiver by using a digital-to-analog converter.

6. The method of claim 1, further comprising:
transmitting a third signal at a third frequency across the channel to the receiver; and
determining a third eye height of the third signal at the third frequency received at the receiver, and determining the transmitter equalization coefficients is further based on the determined third eye height.

7. The method of claim 1, further comprising determining a number of equalization taps.

8. The method of claim 7, wherein determining the number of equalization taps includes determining a ratio of the determined first eye height to the determined second eye height, comparing the ratio to a threshold, and determining the number of transmitter equalization taps based on the comparing.

9. A method comprising:
receiving, from a channel, a plurality of signals, the plurality of signals having a same amplitude and different frequencies;
determining an eye height of the clock signal at each of the plurality of frequencies;
determining a frequency response of the channel based on the determined eye heights at each of the frequencies; and
determining an inverse frequency response of the channel based on the determined frequency response.

10. The method of claim 9, further comprising adjusting signals to be transmitted from the transmitter using the transmitter equalization coefficients based on the determined inverse frequency response.

11. The method of claim 10, further comprising transmitting the adjusted signals from the transmitter to a receiver.

12. The method of claim 9, wherein determining the eye heights at the plurality of frequencies includes adjusting an amplifier of a receiver to determine each of the eye heights.

13. The method of claim 9, further comprising determining a number of equalization taps by:
determining a ratio of the determined eye height at a first one of the frequencies to the determined eye height at a second frequency,
comparing the ratio to a threshold, and
determining the number of transmitter equalization taps based on the comparing.

14. A system comprising:
a channel;
a transmitter including a driver to transmit signals across the channel at different ones of a plurality of frequencies;
a receiver to receive the transmitted signals from the channel and to determine an eye height of the received digital signals at each of the plurality of frequencies; and
a processor to receive data regarding the determined eye height at each of the plurality of frequencies, the processor to determine a frequency response of the channel based on the determined eye heights at each of the plurality of frequencies, to determine an inverse frequency response of the channel based on the determined frequency response and to determine transmitter equalization coefficients based on the determined inverse frequency response.

15. The system of claim 14, wherein the transmitter to adjust parameters of the driver based on the determined transmitter equalization coefficients.

16. The system of claim 15, wherein the transmitter to transmit signals across the channel to the receiver using the adjusted parameters.

17. The system of claim 14, wherein the receiver includes an amplifier to receive the signals and to determine the eye heights of the received clock signals.

18. The system of claim 17, wherein the receiver further includes a digital-to-analog converter (DAC) to determine each of the eye heights with the amplifier.

19. The system of claim 14, wherein the processor to determine a number of equalization taps by:
determining a ratio of the determined eye height at two of the plurality of frequencies,
comparing the ratio to a threshold, and
determining the number of transmitter equalization taps based on the comparing.
